(19) United States
(12) Patent Application Publication
(10) Pub. No.: US 2026/0336034 A1
(43) Pub. Date: Oct. 29, 2026

(54) LASER CUTTING METHOD AND DEVICE FOR HEAVY COMPONENT ASSISTED BY MICRO-NANO PARTICLE IMPACT REINFORCEMENT

(71) Applicants: Guangdong University of Technology, Guangzhou (CN); Guangdong Longxin Laser Intelligent Equipment Co., Ltd, Foshan (CN)

(72) Inventors: YU DENG, Guangzhou (CN); GUOZHANG XIA, Foshan (CN); ZIHONG CEN, Guangzhou (CN); HAOBIN LAO, Foshan (CN); TINGYIN HUANG, Guangzhou (CN); CHANGBIN JI, Foshan (CN); YUANLE LIANG, Foshan (CN); XUECHAO XIAO, Foshan (CN)

(21) Appl. No.: 19/630,687

(22) Filed: Mar. 27, 2026

(30) Foreign Application Priority Data
Apr. 24, 2025 (CN) 202510523198.X

(51) Int. Cl. B23K 26/38; B23K 26/02

(52) U.S. Cl. CPC B23K 26/38; B23K 26/02

(57) ABSTRACT

The present disclosure relates to the field of laser cutting technology, and discloses a laser cutting method and a laser cutting device for heavy component assisted by micro-nano particle impact reinforcement. According to the disclosure, the method includes the following steps: step 1: placing a workpiece to be cut at a designated cutting station; step 2: simultaneously outputting a micro-nano particle gas-solid mixture and a laser beam, both acting together on the workpiece for cutting; and step 3: spraying the micro-nano particle gas-solid mixture onto the workpiece surface, using high-kinetic-energy micro-nano particles to impact a heat affected zone of a cutting region, so as to detach slag from the workpiece surface; and the device includes a control cabinet and a pump source electrically connected to one side of the control cabinet, a spray head electrically connected to the control cabinet is mounted on a cutting platform.

### CROSS-REFERENCE TO RELATED APPLICATION

This application claims priority of Chinese Patent Application No. 202510523198.X, filed on Apr. 24, 2025, the entire contents of which are incorporated herein by reference.

### TECHNICAL FIELD

The present disclosure relates to the field of laser cutting technology, and in particular to a laser cutting method and a laser cutting device for heavy component assisted by micro-nano particle impact reinforcement.

### BACKGROUND

Laser cutting technology is an advanced processing method based on high-energy laser beams, and is widely used in the processing of heavy and irregularly shaped metal structural components. With the increasing demand for high-precision and high-efficiency processing in the manufacturing industry, laser cutting technology, since its development in the 1960s, has gradually integrated numerical control technology and multi-axis control, achieving efficient processing of complex structures such as irregularly shaped tubular members and curved surface components. The basic principle thereof is to utilize a laser generator (e.g., a CO2 laser or a fiber laser) to generate a high-power-density laser beam, which is focused by an optical system and irradiated onto a metal surface, rapidly heating the material to a melting or vaporization temperature, while an assist gas (e.g., oxygen, nitrogen, or air) blows away the molten material, ultimately forming a cut kerf. From the perspective of the working principle of laser cutting, during the processing, the high-energy laser acts on the material surface, rapidly melting and partially vaporizing the same, while the assist gas blows the molten material away from the cut kerf region.

However, the methods and devices for removing molten material in the prior art have the following drawbacks:
high-pressure assist gas blowing is one of the most commonly used methods. This method utilizes high-pressure gas (e.g., oxygen, nitrogen, or air) to directly blow away slag during the cutting process. However, oxygen can support combustion to improve cutting efficiency but may cause oxidation, while nitrogen can prevent oxidation but is relatively costly;
mechanical removal methods (e.g., grinding, polishing, and tapping) are simple to operate but are labor-intensive, may damage the workpiece, are not suitable for complex-shaped parts, and consume a relatively large amount of abrasive materials. Chemical or electrochemical methods (e.g., pickling and electropolishing) can effectively remove slag, but tend to generate pollution, may corrode the workpiece if not properly handled, and entail high waste liquid treatment costs;
laser cleaning technology offers the advantages of high efficiency and non-damage, but the equipment cost is high, the operational energy consumption is large, and its effectiveness is limited for certain highly reflective metals;
ultrasonic cleaning is suitable for precision small parts, but has poor cleaning effect on stubborn slag, typically requires combination with chemical cleaning, and the equipment cost is relatively high;
high-pressure water jet cleaning can remove slag, but consumes a large amount of water, requires bulky equipment, and may cause microscopic damage to the workpiece surface;
cryogenic freezing and peeling utilizes the difference in thermal expansion coefficients of materials to remove slag, but its scope of application is limited, being effective only for specific materials, while also requiring expensive refrigeration equipment and affecting production efficiency.

### SUMMARY

The present disclosure provides a laser cutting method and a laser cutting device for heavy component assisted by micro-nano particle impact reinforcement, which solves the problems in the above-mentioned background art that the use of high-pressure gas, mechanical removal methods, chemical or electrochemical methods, ultrasonic cleaning, high-pressure water jet method, and cryogenic freezing and peeling all have drawbacks, and there is a lack of an efficient, economical, and environmentally friendly slag removal means.

The present disclosure provides the following technical solution: a laser cutting method for heavy component assisted by micro-nano particle impact reinforcement, including the following steps:
step 1: placing a workpiece to be cut at a designated cutting station;
step 2: simultaneously outputting a micro-nano particle gas-solid mixture and a laser beam, both acting together on the workpiece for cutting; and
step 3: spraying the micro-nano particle gas-solid mixture onto the workpiece surface, using high-kinetic-energy micro-nano particles to impact a heat affected zone of a cutting region, so as to detach slag from the workpiece surface.

The present disclosure also discloses a laser cutting device, including a laser cutting method for heavy component assisted by micro-nano particle impact reinforcement, the device including a control cabinet and a pump source electrically connected to one side of the control cabinet, a cutting platform for placing a workpiece to be cut is provided on one side of the control cabinet, and a spray head electrically connected to the control cabinet is mounted on the cutting platform.

As an optional solution of the laser cutting device for heavy component assisted by micro-nano particle impact reinforcement according to the present disclosure, wherein: an adjustable support assembly is mounted on the cutting platform, the support assembly includes a first support frame and a first support plate, an adjusting screw rod is threadedly connected within the first support frame, and a top end of the adjusting screw rod penetrates through the first support plate and is rotatably connected to a bottom of the first support plate.

As an optional solution of the laser cutting device for heavy component assisted by micro-nano particle impact reinforcement according to the present disclosure, wherein: a pump source is disposed within the first support plate, an optical part is provided at a bottom of the pump source, and a cooling part is disposed between the optical part and the spray head.

As an optional solution of the laser cutting device for heavy component assisted by micro-nano particle impact reinforcement according to the present disclosure, wherein: a light source controller is disposed within the first support frame, and the light source controller is electrically connected to the optical part.

As an optional solution of the laser cutting device for heavy component assisted by micro-nano particle impact reinforcement according to the present disclosure, wherein: a second support frame is disposed on the first support plate, a gas-solid mixing tank is installed within the second support frame, and the gas-solid mixing tank is connected to the pump source via a high-pressure pump tube.

As an optional solution of the laser cutting device for heavy component assisted by micro-nano particle impact reinforcement according to the present disclosure, wherein: a laser channel is defined at a central position within the spray head, swirl guide channels are annularly and equidistantly defined around an outer circumference of the laser channel, and the swirl guide channels are arranged in a spiral annular configuration.

As an optional solution of the laser cutting device for heavy component assisted by micro-nano particle impact reinforcement according to the present disclosure, wherein: collecting assemblies are symmetrically disposed on two sides of the cutting platform, each collecting assembly includes a collecting frame and a baffle plate, a torsion portion is disposed between the baffle plate and the collecting frame, the torsion portion includes a rotating shaft rotatably mounted within the collecting frame, a torsion spring is connected between the rotating shaft and the collecting frame, and the baffle plate is connected to one side of the rotating shaft.

As an optional solution of the laser cutting device for heavy component assisted by micro-nano particle impact reinforcement according to the present disclosure, wherein: scrapers are symmetrically disposed on a surface of the baffle plate, the scrapers are slidably connected to one side of the baffle plate, a second support plate is connected to one side of the baffle plate, a moving block is connected to one side of the second support plate via a ball head, and the moving block and the collecting frame are slidably connected to a frame of the collecting frame.

As an optional solution of the laser cutting device for heavy component assisted by micro-nano particle impact reinforcement according to the present disclosure, wherein: a driving assembly is disposed between the second support plate and the collecting frame, the driving assembly includes a left-handed screw rod and a right-handed screw rod, the left-handed screw rod and the right-handed screw rod are both rotatably mounted within the collecting frame, a motor is provided at one end of the left-handed screw rod, internally threaded sleeves are disposed on surfaces of the left-handed screw rod and the right-handed screw rod, a connecting block is connected to a bottom end of the second support plate, and the internally threaded sleeves are rotatably connected within the connecting block via bearings.

The present disclosure has the following beneficial effects:

First, according to the laser cutting method and the laser cutting device for heavy component assisted by micro-nano particle impact reinforcement, the pump source is controlled by the control cabinet to excite a working medium, and a gain medium is utilized to generate a medium for stimulated radiation, which determines a wavelength and output characteristics of a laser. In combination with relevant components in an optical system, a transmission efficiency of the laser is improved by a controller. Photons of the stimulated radiation in a resonant cavity are reflected multiple times within the cavity and finally output the laser. A cooling system is used to control a temperature of a laser generator, preventing overheating of the working medium and optical elements.

Second, according to the laser cutting method and the laser cutting device for heavy component assisted by micro-nano particle impact reinforcement, by providing a novel spray head, the micro-nano particle gas-solid mixture and the laser beam are simultaneously output; during output, a laser focus is controlled to act on a surface of the workpiece to be processed, causing the surface to generate high temperature and vaporize a material, and vaporized molten material is ejected; at the same time, the swirling gas mixture in the spray head acts on the workpiece surface, the high-pressure rotating gas enables a portion of slag having a relatively small volume to leave the workpiece surface, micro-nano particles entrained therein undergo self-rotation under an action of the swirl-type spray head, impacting the slag cladded on the workpiece surface, and the self-rotating micro-nano particles produce a rotary cutting action on the surface slag, making it easier for the slag to detach from the workpiece surface.

Third, according to the laser cutting method and the laser cutting device for heavy component assisted by micro-nano particle impact reinforcement, the coaxial swirl spray head causes the micro-nano particles to rotate and changes an impact direction thereof, so as to form a certain angle with the workpiece surface, and under driving of high-pressure gas, collides with slag to generate a tangential force. According to mechanical analysis, the tangential force can better promote detachment of the slag from the workpiece surface, and the strong mechanical impact force can effectively peel off the slag, causing it to detach from the workpiece surface, thereby achieving an effect of removing cladded material; meanwhile, driven by the high-pressure gas, the high-kinetic-energy micro-nano particles impact a heat affected zone of a cutting region, changing a surface crystal structure thereof, effectively reducing an area of the heat affected zone and microscopic defects, improving mechanical properties such as strength of the workpiece surface material, and achieving an effect of enhancing workpiece surface performance while removing slag.

Forth, according to the laser cutting method and the laser cutting device for heavy component assisted by micro-nano particle impact reinforcement, a collecting frame is provided to collect splashed molten material, wherein a baffle plate is disposed within the collecting frame, a rotating shaft is connected to one side of the baffle plate, a torsion spring is disposed between two ends of the rotating shaft and the collecting frame, and an elastic force is utilized to provide a buffering force for the baffle plate, preventing the splashed molten material from rebounding onto the workpiece surface.

Fifth, according to the laser cutting method and the laser cutting device for heavy component assisted by micro-nano particle impact reinforcement, a scraper movably disposed on one side of the baffle plate is driven by a driving assembly, enabling the scraper to scrape off splashed slag adhered to a surface of the baffle plate.

### BRIEF DESCRIPTION OF THE DRAWINGS

FIG. 1 is a schematic perspective structural view according to the present disclosure.

FIG. 2 is a schematic side cross-sectional structural view of a spray head according to the present disclosure.

FIG. 3 is a schematic top cross-sectional structural view of the spray head according to the present disclosure.

FIG. 4 is an enlarged schematic structural view of portion A of FIG. 1 according to the present disclosure.

FIG. 5 is a schematic perspective structural view of a collecting frame according to the present disclosure.

FIG. 6 is a schematic cross-sectional structural view of the collecting frame according to the present disclosure.

FIG. 7 is an enlarged schematic structural view of portion B of FIG. 6 according to the present disclosure.

In the figures: 1: control cabinet; 2: pump source; 3: optical part; 4: gas-solid mixing tank; 5: light source controller; 6: cooling part; 7: spray head; 8: collecting frame; 9: cutting platform; 10: first support frame; 11: adjusting screw rod; 12: first support plate; 13: second support frame; 14: laser channel; 15: swirl guide channel; 16: baffle plate; 17: scraper; 18: second support plate; 19: rotating shaft; 20: torsion spring; 21: moving block; 22: ball head; 23: motor; 24: left-handed screw rod; 25: right-handed screw rod; 26: connecting block; and 27: internally threaded sleeve.

### DETAILED DESCRIPTION OF THE EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by a person of ordinary skill in the art without making creative efforts shall fall within the protection scope of the present disclosure.

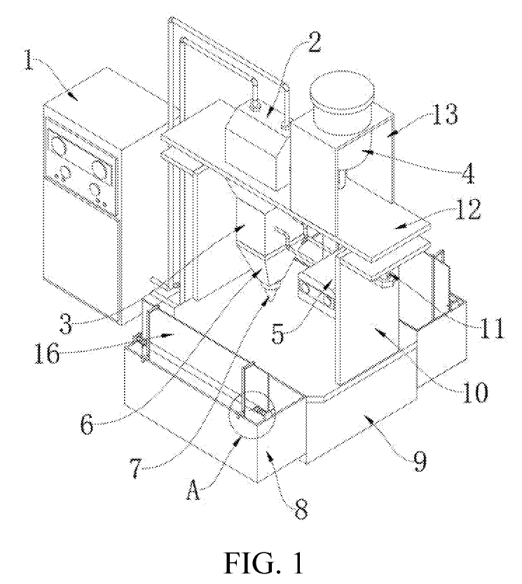

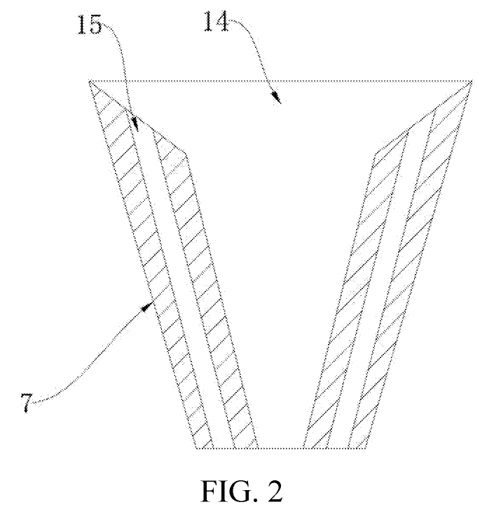

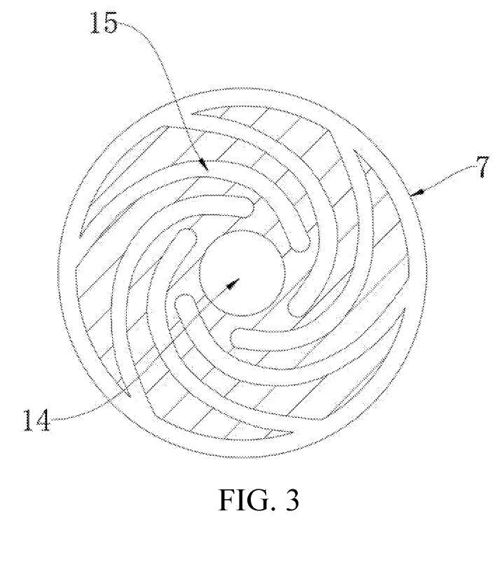

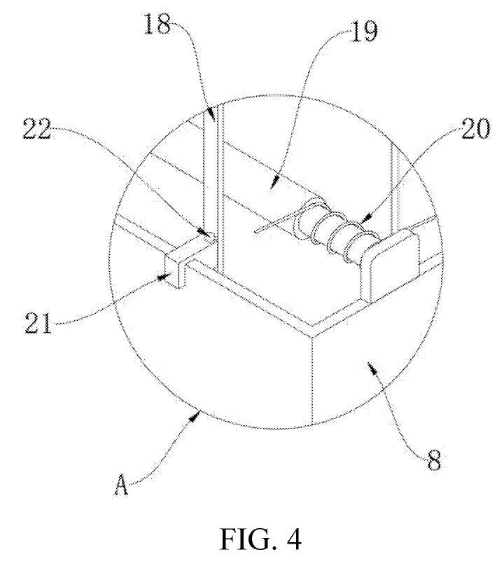

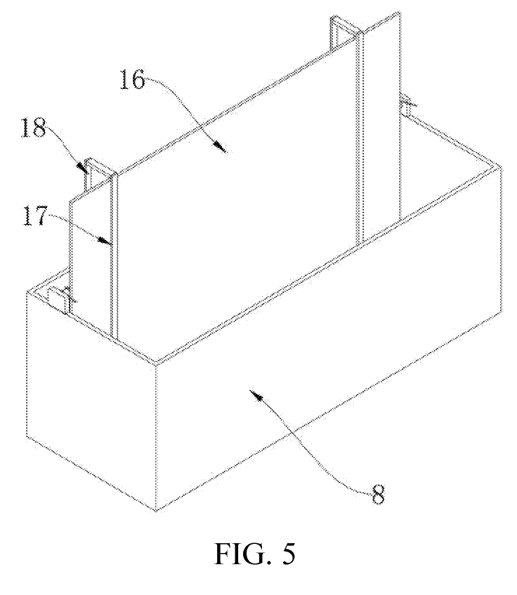

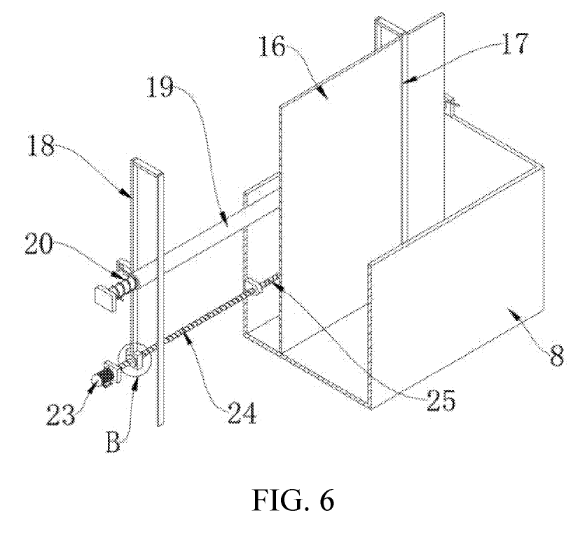

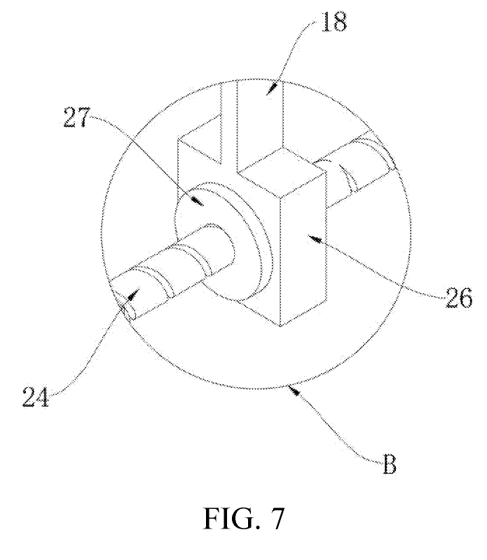

Embodiment 1: as shown in FIGS. 1-7, the present disclosure discloses a laser cutting method for heavy component assisted by micro-nano particle impact reinforcement, including the following steps:
step 1: placing a workpiece to be cut at a designated cutting station;
step 2: simultaneously outputting a micro-nano particle gas-solid mixture and a laser beam, both acting together on the workpiece for cutting; and
step 3: spraying the micro-nano particle gas-solid mixture onto the workpiece surface, using high-kinetic-energy micro-nano particles to impact a heat affected zone of a cutting region, so as to detach slag from the workpiece surface.

In this embodiment, the pump source is controlled by the control cabinet to excite a working medium and generate a laser; in combination with relevant components in an optical system, a controller is used to improve the transmission efficiency of the laser, so as to enhance cutting precision and efficiency; to address the problem of significant slag adhesion on large-thickness workpieces during laser cutting, a laser cutting method for heavy component assisted by micro-nano particle impact reinforcement is provided. By means of the simultaneously output micro-nano particle gas-solid mixture, slag removal efficiency is improved and processing quality is optimized.

Embodiment 2: this embodiment is an explanation based on Embodiment 1. Specifically, as shown in FIGS. 1-7, the micro-nano particle impact reinforcement assisted laser cutting device for heavy component provided by the present disclosure can be used to implement the above-mentioned laser cutting method for heavy component assisted by micro-nano particle impact reinforcement. The micro-nano particle impact reinforcement assisted laser cutting device for heavy component includes a control cabinet 1 and a pump source 2 electrically connected to one side of the control cabinet 1, a cutting platform 9 for placing a workpiece to be cut is disposed on one side of the control cabinet 1, a spray head 7 electrically connected to the control cabinet 1 is mounted on the cutting platform 9, a laser channel 14 is defined at a central position within the spray head 7, swirl guide channels 15 are annularly and equidistantly defined around an outer circumference of the laser channel 14, and the swirl guide channels 15 are arranged in a spiral annular configuration.

In this embodiment, the spray head 7 is configured as a coaxial laser swirling nozzle, the spray head 7 is internally divided into two structural parts, including a laser channel 14 and a swirl guide channel 15, the laser channel 14 is configured as a hollow structure for laser transmission; the swirl guide channel 15 is a swirl nozzle, configured to conduct the micro-nano particle gas-solid mixture.

During cutting, the control cabinet 1, the pump source 2, and an external high-pressure gas booster pump are activated, and high-pressure assist gas is used to drive micro-nano particles for impact removal of slag. During the laser cutting process, when the micro-nano particles impact the adhered slag, the strong mechanical impact force thereof can effectively peel off the slag, causing it to detach from the workpiece surface; at the same time, the micro-nano particles obtain extremely high kinetic energy under the drive of the high-pressure gas flow, and move at high speed with the gas flow to the workpiece surface, performing impact reinforcement on the surface region, effectively reducing the area of the heat affected zone and microscopic defects, and improving the performance of the workpiece surface material.

A laser control system is disposed within the control cabinet 1, the laser control system is configured to adjust parameters such as output power, pulse mode, and frequency of a laser, so as to ensure the laser operates according to set requirements, and provide safety protection functions.

It should be noted that the hollow structure laser channel 14 disposed within the spray head 7 is connected to the optical part 3, and is configured to guide the laser beam output from the optical part 3.

The spray head 7 is configured as a swirl nozzle, and guides the movement of the micro-nano particle gas-solid mixture through the built-in rotating channel, i.e., the swirl guide channel 15, causing the mixture to undergo self-rotation when passing through the spray head 7, and to be ejected from the swirl guide channel 15 defined within the spray head 7. The high-pressure gas drives the micro-nano particles to generate a swirling flow, changing a moving direction of the micro-nano particles. The spray head 7 simultaneously outputs the micro-nano particle gas-solid mixture and the laser beam, both acting together on the workpiece.

In this embodiment, by providing a novel spray head, the micro-nano particle gas-solid mixture and the laser beam are simultaneously output; during output, a laser focus is controlled to act on a surface of the workpiece to be processed, causing the surface to generate high temperature and vaporize a material, and vaporized molten material is ejected; at the same time, the swirling gas mixture in the spray head acts on the workpiece surface, the high-pressure rotating gas enables a portion of slag having a relatively small volume to leave the workpiece surface, micro-nano particles entrained therein undergo self-rotation under an action of the swirl-type spray head, impacting the slag cladded on the workpiece surface, and the self-rotating micro-nano particles produce a rotary cutting action on the surface slag, making it easier for the slag to detach from the workpiece surface.

Further, the coaxial swirl spray head causes the micro-nano particles to rotate and changes an impact direction thereof, so as to form a certain angle between the micro-nano particles and the workpiece surface, and under driving of high-pressure gas, the micro-nano particles collide with slag to generate a tangential force. According to mechanical analysis, the tangential force can better promote detachment of the slag from the workpiece surface, and the strong mechanical impact force can effectively peel off the slag, causing it to detach from the workpiece surface, thereby achieving an effect of removing cladded material; meanwhile, driven by the high-pressure gas, the high-kinetic-energy micro-nano particles impact a heat affected zone of a cutting region, changing a surface crystal structure thereof, effectively reducing an area of the heat affected zone and microscopic defects, improving mechanical properties such as strength of the workpiece surface material, and achieving an effect of enhancing workpiece surface performance while removing slag.

An adjustable support assembly is mounted on the cutting platform 9, the support assembly includes a first support frame 10 and a first support plate 12, an adjusting screw rod 11 is threadedly connected within the first support frame 10, a top end of the adjusting screw rod 11 penetrates through the first support plate 12 and is rotatably connected to a bottom of the first support plate 12, a pump source 2 is disposed within the first support plate 12, an optical part 3 is provided at a bottom of the pump source 2, a cooling part 6 is disposed between the optical part 3 and the spray head 7, a light source controller 5 is disposed within the first support frame 10, and the light source controller 5 is electrically connected to the optical part 3.

In this embodiment, the workpiece is placed on the cutting platform 9, and the first support frame 10 and the first support plate 12 are disposed on the cutting platform 9, respectively supporting the pump source 2, the optical part 3, the light source controller 5, the cooling part 6, and the spray head 7, ensuring stability of the laser cutting device.

According to a thickness of the workpiece, by rotating the adjusting screw rod 11, a distance between the first support plate 12 and the cutting platform 9 is adjusted, thereby adjusting a height of the spray head 7, and expanding an application scope of the cutting device.

A second support frame 13 is disposed on the first support plate 12, a gas-solid mixing tank 4 is installed within the second support frame 13, and the gas-solid mixing tank 4 is connected to the pump source 2 via a high-pressure pump tube.

In this embodiment, the gas-solid mixing tank 4 is a micro-nano particle gas-solid mixing device, configured to generate a micro-nano particle mixed gas, so as to uniformly output micro-nano particles through a high-pressure pump tube. The gas-solid mixing tank 4 includes a gas-solid mixing system, a micro-nano particle filtration system, a mixing concentration controller, a pressure controller, and other devices, enabling real-time adjustment of outlet pressure and ensuring that the micro-nano particles have sufficient kinetic energy.

In this embodiment, the electrically connected optical part 3 and light source controller 5 are provided, the light source controller 5 is configured to control relevant components within the optical part 3, including lenses, beam expanders, collimators, and the like, for focusing, shaping, and adjusting a laser beam, so as to focus the beam onto the workpiece and improve transmission efficiency of the laser. A resonant cavity is disposed within the optical part 3, the resonant cavity is composed of a pair of reflectors (a total reflector and a partial reflector), configured to enhance oscillation of light and selectively amplify light of a specific wavelength, so that photons of stimulated radiation are reflected multiple times within the cavity and finally output a laser.

It should be noted that the optical part 3 includes a fiber laser, a laser lens, a focusing lens, and a reflector. This part of the structure is well known to those skilled in the art and will not be described in detail.

A cooling part 6 is provided, configured to control a temperature of a laser generator and prevent overheating of a working medium and optical elements. A circulating water-cooling device is disposed within the cooling part 6, which can effectively remove heat generated by the laser generator.

The cooling part 6 includes a cooling water tank, a cooling pump, a cooling pipeline, a radiator (or heat exchanger), a temperature sensor, a filter, and a control system. This part of the structure is well known to those skilled in the art and will not be described in detail.

Embodiment 3: this embodiment is an explanation based on Embodiment 1. Specifically, as shown in FIGS. 1-7, collecting assemblies are symmetrically disposed on two sides of the cutting platform 9, each collecting assembly includes a collecting frame 8 and a baffle plate 16, a torsion portion is disposed between the baffle plate 16 and the collecting frame 8, the torsion portion includes a rotating shaft 19 rotatably mounted within the collecting frame 8, a torsion spring 20 is connected between the rotating shaft 19 and the collecting frame 8, and the baffle plate 16 is connected to one side of the rotating shaft 19.

This embodiment is intended to collect slag detached from the workpiece surface. Slag is sprayed onto the baffle plate 16 and then slides down from the baffle plate 16 into the collecting frame 8 for collection. To prevent the slag from rebounding onto the workpiece after being sprayed onto the surface of the baffle plate 16, the baffle plate 16 is configured as an elastic rotating device. A rotating shaft 19 is connected to one side of the baffle plate 16, two ends of the rotating shaft 19 are rotatably connected to the collecting frame 8, and a torsion spring 20 is connected between the rotating shaft 19 and the collecting frame 8. When slag is sprayed and impacts the baffle plate 16, the torsion spring 20 provides a buffer for an impact force received by the baffle plate 16, effectively preventing the slag from rebounding onto the workpiece after being sprayed.

In this embodiment, a collecting frame is provided to collect splashed molten material, wherein a baffle plate is disposed within the collecting frame, a rotating shaft is connected to one side of the baffle plate, a torsion spring is disposed between two ends of the rotating shaft and the collecting frame, and an elastic force is utilized to provide a buffering force for the baffle plate, preventing the splashed molten material from rebounding onto the workpiece surface.

Embodiment 4: this embodiment is an explanation based on Embodiment 1. Specifically, please refer to FIGS. 1-7, scrapers 17 are symmetrically disposed on a surface of the baffle plate 16, the scrapers 17 are slidably connected to one side of the baffle plate 16, a second support plate 18 is connected to one side of the baffle plate 16, a moving block 21 is connected to one side of the second support plate 18 via a ball head 22, and the moving block 21 and the collecting frame 8 are slidably connected to a frame of the collecting frame 8. A driving assembly is disposed between the second support plate 18 and the collecting frame 8, the driving assembly includes a left-handed screw rod 24 and a right-handed screw rod 25, the left-handed screw rod 24 and the right-handed screw rod 25 are both rotatably mounted within the collecting frame 8, a motor 23 is provided at one end of the left-handed screw rod 24, internally threaded sleeves 27 are disposed on surfaces of the left-handed screw rod 24 and the right-handed screw rod 25, a connecting block 26 is connected to a bottom end of the second support plate 18, and the internally threaded sleeves 27 are rotatably connected within the connecting block 26 via bearings.

In this embodiment, to prevent insufficiently cooled slag from being sprayed onto the surface of the baffle plate 16 and adhering to the baffle plate 16 without falling into the collecting frame 8, two sets of scrapers 17 are symmetrically disposed on the surface of the baffle plate 16 to scrape off the slag and cause the slag to fall into the collecting frame 8.

When cleaning the baffle plate 16, the motor 23 is activated, driving the left-handed screw rod 24 and the right-handed screw rod 25 to rotate, the internally threaded sleeves 27 rotate within the connecting blocks 26, the connecting blocks 26 are connected to the second support plate 18, the second support plate 18 drives the scrapers 17 to move on the surface of the baffle plate 16. Due to different rotation directions of the left-handed screw rod 24 and the right-handed screw rod 25, the left-handed screw rod 24 and the right-handed screw rod 25 can be simultaneously driven to reciprocate on two sides of the baffle plate 16, improving efficiency of scraping off slag and further increasing a slag collection speed.

It should be noted that the connection between the ball head 22 and the moving block 21 not only enables the second support plate 18 to move on the collecting frame 8, but also prevents interference between the moving block 21 and the baffle plate 16 when the baffle plate 16 undergoes torsion.

In this embodiment, a scraper movably disposed on one side of the baffle plate is driven by a driving assembly, enabling the scraper to scrape off splashed slag adhered to a surface of the baffle plate.

It should be noted that in the present disclosure, relational terms such as first and second, etc. are used merely to distinguish one entity or operation from another entity or operation, and do not necessarily require or imply any such actual relationship or order between these entities or operations. Moreover, the terms "comprise", "include", or any other variations thereof are intended to cover a non-exclusive inclusion, such that a process, method, article, or apparatus that includes a list of elements includes not only those elements but also other elements not expressly listed, or elements inherent to such process, method, article, or apparatus.

The above descriptions are only preferred embodiments of the present disclosure. It should be noted that those of ordinary skill in the art may also make several improvements and modifications without departing from the technical principles of the present disclosure, and these improvements and modifications should also be regarded as the protection scope of the present disclosure.

1. A laser cutting method for heavy component assisted by micro-nano particle impact reinforcement, comprising the following steps:
step 1: placing a workpiece to be cut at a designated cutting station;
step 2: simultaneously outputting a micro-nano particle gas-solid mixture and a laser beam, both acting together on the workpiece for cutting;
step 3: spraying the micro-nano particle gas-solid mixture onto the workpiece surface, using high-kinetic-energy micro-nano particles to impact a heat affected zone of a cutting region, so as to detach slag from the workpiece surface;
a laser cutting method for heavy component assisted by micro-nano particle impact reinforcement, implemented based on a micro-nano particle impact reinforcement assisted laser cutting device for heavy component, wherein the device comprises a control cabinet (1) and a pump source (2) electrically connected to one side of the control cabinet (1), a cutting platform (9) for placing a workpiece to be cut is disposed on one side of the control cabinet (1), a spray head (7) electrically connected to the control cabinet (1) is mounted on the cutting platform (9);
an adjustable support assembly is mounted on the cutting platform (9), the support assembly comprising a first support frame (10) and a first support plate (12), an adjusting screw rod (11) is threadedly connected within the first support frame (10), a top end of the adjusting screw rod (11) penetrates through the first support plate (12) and is rotatably connected to a bottom of the first support plate (12);
a pump source (2) is disposed within the first support plate (12), an optical part (3) is provided at a bottom of the pump source (2), and a cooling part (6) is disposed between the optical part (3) and the spray head (7).

2. The laser cutting method for heavy component assisted by micro-nano particle impact reinforcement according to claim 1, wherein a light source controller (5) is disposed within the first support frame (10), and the light source controller (5) is electrically connected to the optical part (3).

3. The laser cutting method for heavy component assisted by micro-nano particle impact reinforcement according to claim 1, wherein a second support frame (13) is disposed on the first support plate (12), a gas-solid mixing tank (4) is installed within the second support frame (13), and the gas-solid mixing tank (4) is connected to the pump source (2) via a high-pressure pump tube.

4. The laser cutting method for heavy component assisted by micro-nano particle impact reinforcement according to claim 1, wherein a laser channel (14) is defined at a central position within the spray head (7), swirl guide channels (15) are annularly and equidistantly defined around an outer circumference of the laser channel (14), and the swirl guide channels (15) are arranged in a spiral annular configuration.

5. The laser cutting method for heavy component assisted by micro-nano particle impact reinforcement according to claim 1, wherein collecting assemblies are symmetrically disposed on two sides of the cutting platform (9), each collecting assembly comprises a collecting frame (8) and a baffle plate (16), a torsion portion is disposed between the baffle plate (16) and the collecting frame (8), the torsion portion comprises a rotating shaft (19) rotatably mounted within the collecting frame (8), a torsion spring (20) is connected between the rotating shaft (19) and the collecting frame (8), and the baffle plate (16) is connected to one side of the rotating shaft (19).

6. The laser cutting method for heavy component assisted by micro-nano particle impact reinforcement according to claim 5, wherein scrapers (17) are symmetrically disposed on a surface of the baffle plate (16), the scrapers (17) are slidably connected to one side of the baffle plate (16), a second support plate (18) is connected to one side of the baffle plate (16), a moving block (21) is connected to one side of the second support plate (18) via a ball head (22), and the moving block (21) and the collecting frame (8) are slidably connected to a frame of the collecting frame (8).

7. The laser cutting method for heavy component assisted by micro-nano particle impact reinforcement according to claim 6, wherein a driving assembly is disposed between the second support plate (18) and the collecting frame (8), the driving assembly comprises a left-handed screw rod (24) and a right-handed screw rod (25), the left-handed screw rod (24) and the right-handed screw rod (25) are both rotatably mounted within the collecting frame (8), a motor (23) is provided at one end of the left-handed screw rod (24), internally threaded sleeves (27) are disposed on surfaces of the left-handed screw rod (24) and the right-handed screw rod (25), a connecting block (26) is connected to a bottom end of the second support plate (18), and the internally threaded
sleeves (27) are rotatably connected within the connecting block (26) via bearings.
